(19) United States
(12) Patent Application Publication
(10) Pub. No.: US 2015/0170617 A1
(43) Pub. Date: Jun. 18, 2015

(54) ELECTRONIC DEVICE, METHOD, AND STORAGE MEDIUM

(71) Applicant: Kabushiki Kaisha Toshiba, Tokyo (JP)

(72) Inventor: Akihiko Noguchi, Ome-shi (JP)

(21) Appl. No.: 14/304,540

(22) Filed: Jun. 13, 2014

Related U.S. Application Data
(60) Provisional application No. 61/916,475, filed on Dec. 16, 2013.

(51) Int. Cl. G09G 5/377; G06F 3/0488; G06T 11/00; G06F 3/044

(52) U.S. Cl. CPC G09G 5/377; G06F 3/044; G06F 3/04883; G06T 11/001; G09G 2340/12

(57) ABSTRACT

According to one embodiment, an electronic device includes an input controller, a detector, a layer controller, and a rendering controller. The input controller is configured to receive data indicative of an object to be rendered on a screen comprising layers. The detector is configured to detect an attribute of the object received by the input controller. The layer controller is configured to assign the object to either an existent layer or a new layer belonging to the layers of the screen, the layers connected with attributes. The rendering controller is configured to render on the screen, objects assigned to the layers.

### CROSS-REFERENCE TO RELATED APPLICATIONS

This application claims the benefit of U.S. Provisional Application No. 61/916,475, filed Dec. 16, 2013, the entire contents of which are incorporated herein by reference.

### FIELD

Embodiments described herein relate generally to an electronic device, a method, and a storage medium.

### BACKGROUND

There is an electronic device having a function of rendering an object on a screen in accordance with an input made by a user. The object includes, for instance, a figure, a character, and a stroke represented by a trail including positions successively specified at a detection surface by an indicator or a finger of the user.

Rendering a lot of objects on a screen causes increase in information volume of the screen and makes it difficult to manage the objects.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating the exemplified external appearance of an electronic device in one embodiment.

FIG. 2 is a block diagram illustrating the exemplified principal structure of the electronic device in the embodiment.

FIG. 3 is a block diagram illustrating the exemplified principal functions of the electronic device in the embodiment.

FIG. 4 is a drawing for explaining an example of how the layers of the electronic device in the embodiment work.

FIG. 5 is a drawing illustrating the exemplified data structure of a management table in the embodiment.

FIG. 6 is a flow chart explaining the exemplified operation of the electronic device in the embodiment.

FIG. 7 is a flow chart explaining an exemplified object input process included in the flow chart of FIG. 6.

FIG. 8 is a drawing explaining an exemplified attribute selection box in the embodiment.

FIG. 9 is a drawing explaining an example of how to select a layer in the embodiment.

### DETAILED DESCRIPTION

Various embodiments will be described hereinafter with reference to the accompanying drawings.

In general, according to one embodiment, an electronic device includes an input controller, a detector, a layer controller, and a rendering controller. The input controller is configured to receive data indicative of an object to be rendered on a screen comprising layers. The detector is configured to detect an attribute of the object received by the input controller. The layer controller is configured to assign the object to either an existent layer or a new layer belonging to the layers of the screen, the layers connected with attributes. The rendering controller is configured to render on the screen, objects assigned to the layers.

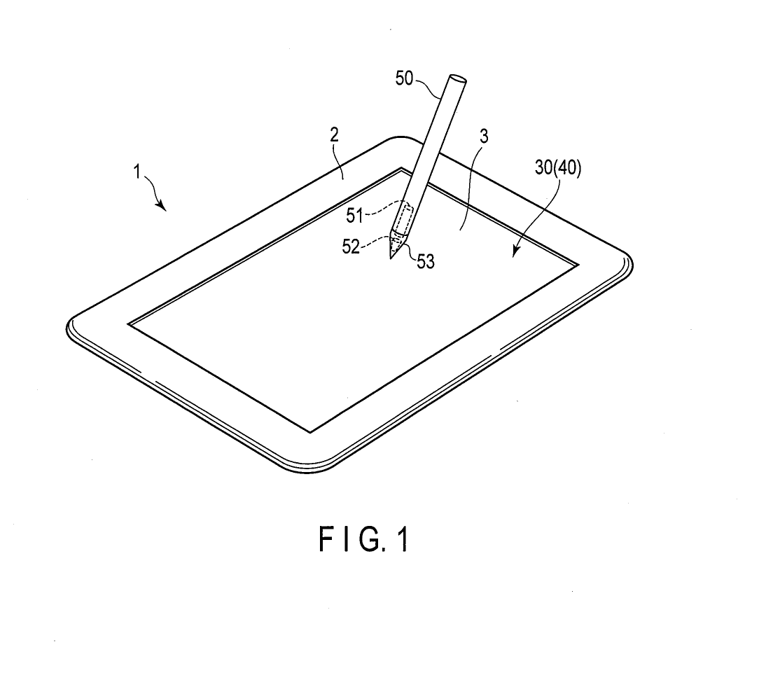

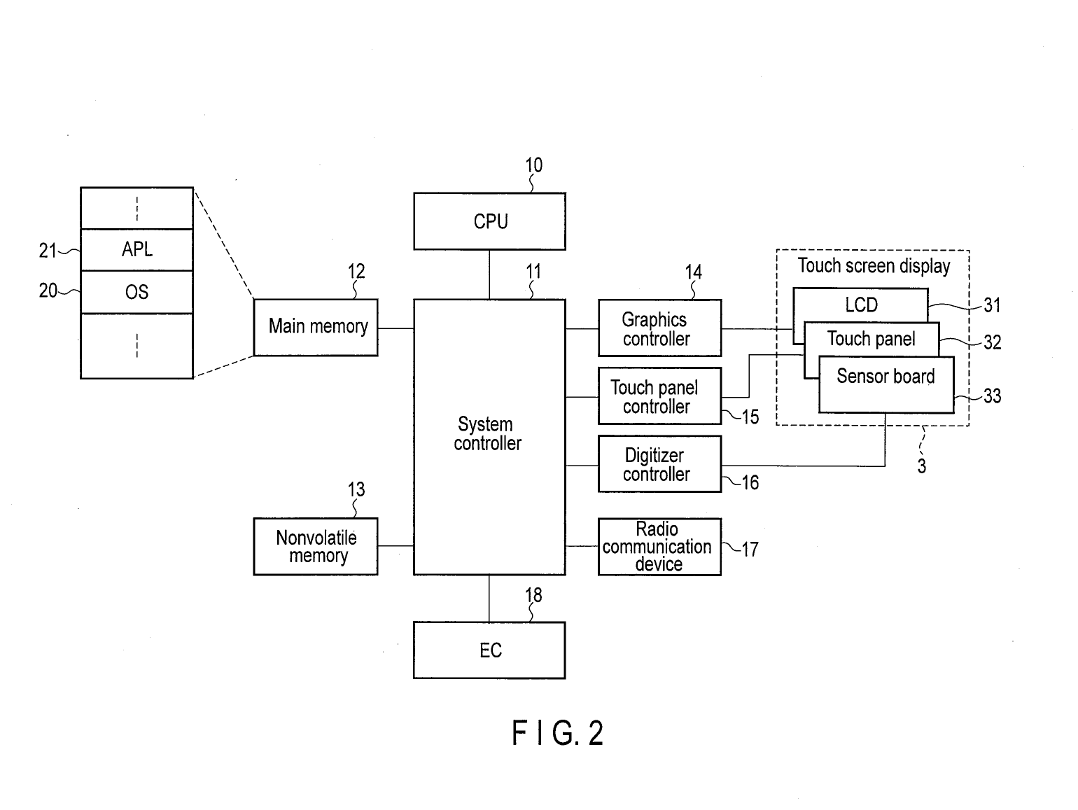

FIG. 1 is the perspective view illustrating the exemplified external appearance of the electronic device in the embodiment. FIG. 2 is the block diagram illustrating the principal structure of the electronic device.

A tablet computer 1 having a slab housing 2 as indicated in FIG. 1 is disclosed as an exemplified electronic device in the present embodiment. The tablet computer 1 has a touch screen display 3. The touch screen display 3 is provided to expose its whole surface from the housing 2. The exposed whole surface is a detection surface 30 for detecting a position which is indicated by an indicator 50 or a finger of a user. The exposed whole surface is a screen 40 for displaying an image or a picture, too.

As indicated in FIG. 2, the tablet computer 1 includes a central processing unit (CPU) 10, a system controller 11, a main memory 12, a nonvolatile memory 13, a graphics controller 14, a touch panel controller 15, a digitizer controller 16, a radio communication device 17, an embedded controller (EC) 18, the above-mentioned touch screen display 3, etc. The touch screen display 3 includes a liquid crystal display (LCD) 31, a touch panel 32, and a sensor board 33. The LCD 31, the touch panel 32, and the sensor board 33 are rectangular flat boards of substantially the same size and are placed one upon another in the mentioned order from the detection surface 30 toward the inside of the housing 2. It is possible that the touch screen display 3 includes instead of the LCD 31 another kind of display such as an organic electroluminescent display.

The CPU 10 executes various pieces of software having been loaded into the main memory 12 from the nonvolatile memory 13, which is a storage device. An operating system (OS) 20 and a plurality of application programs (APL) are included in the pieces of software. An application program 21 concerned with rendering tools is included in the plurality of application programs.

The system controller 11 is a device for controlling a connection of the local bus of the CPU 10 to any components of various kinds. The system controller 11 includes a memory controller for controlling access to the main memory 12. In addition, the system controller 11 has a function of communicating with the graphics controller 14, the touch panel controller 15, and the digitizer controller 16.

The graphics controller 14 is a display controller for controlling the LCD 31, which is used as a display monitor for the tablet computer 1. The graphics controller 14 generates a display signal, which is sent to the LCD 31. The LCD 31 displays an image based on the display signal.

The radio communication device 17 is a device configured to execute radio communication using, for instance, wireless local area networks (LANs) or 3G mobile communication networks. The EC 18 is a one-chip microcomputer having a function of controlling power supply to each device of the tablet computer 1.

The touch panel 32 and the touch panel controller 15 detect the coordinates of the position where a material body touches the detection surface 30. The touch panel 32 and the touch panel controller 15 may use capacitance for the detection. In such a case, the touch panel 32 includes an electrode pattern, which forms a lot of electrodes and is made of transparent material such as ITO, etc. It further includes an insulating layer, which is formed on the electrode pattern. When an electrically conductive body such as a finger of the user touches the detection surface 30, a change in capacitance will occur between the electrically conductive body and some electrodes in the electrode pattern that are adjacent to the position where the body touches. The touch panel controller 15 detects based on the change in capacitance the coordinates of the position where the conductive body touches the detection surface 30. The detection method of this kind allows a multiple point detection of the position where the conductive body touches.

The sensor board 33 and the digitizer controller 16 detect the coordinates of the position which the indicator 50 indicates on the detection surface 30. In this embodiment, the sensor board 33 and the digitizer controller 16 compose an electromagnetic induction type digitizer. Namely, the sensor board 33 includes a plurality of loop coils arranged in an X-axis direction and a plurality of loop coils arranged in a Y-axis direction perpendicular to the X-axis direction.

As indicated in FIG. 1, the indicator 50 has the shape of a pen. The indicator 50 includes inside of it a resonant circuit 51, which is a magnetic field generating source, and a brushstroke strength detector 52. The resonant circuit 51 includes at least a coil and a capacitor, and causes the transfer of electromagnetic waves to occur between the coil of the resonant circuit and the loop coils of the sensor board 33. The brushstroke strength detector 52 includes a variable capacitor, which will change in capacitance in accordance with the pressure applied to the tip portion 53 of the indicator 50.

When electric current flows through the loop coils of the sensor board 33, magnetic fields will be generated from the sensor board 33 and thus the detection surface 30 will be wholly covered with the magnetic fields. The magnetic fields cause the resonant circuit 51 to generate inductive voltages, and thus energy will be accumulated in the resonant circuit 50. When the supply of the electric current to the loop coils stops, the energy accumulated in the resonant circuit 51 causes the resonant circuit 51 to generate a magnetic field. The magnetic field thus generated in turn causes any loop coil adjacent to the indicator 50 to generate inductive voltage. The inductive voltage having been thus generated at the aforementioned any loop coil is amplified by an amplifier circuit and is then inputted into the digitizer controller 16 as a detection signal. Note that the resonant circuit 51 is so constructed as to change in resonant frequency in accordance with the capacitance of the variable capacitor of the brushstroke strength detector 52.

The digitizer controller 16 detects, based on the signal having been inputted from the sensor board 33, the coordinates of the position which the indicator 50 specifies on the detection surface 30. The digitizer controller 16 furthermore determines a brushstroke strength value based on the change amount of the resonant frequency of the resonant circuit 51. Making a comparison between the brushstroke strength value and a threshold value, which is a value for separating a case where the indicator 50 touches the detection surface 30 and a case where the indicator 50 does not touch the detection surface 30, allows making a decision whether or not the indicator 50 touches the detection surface 30.

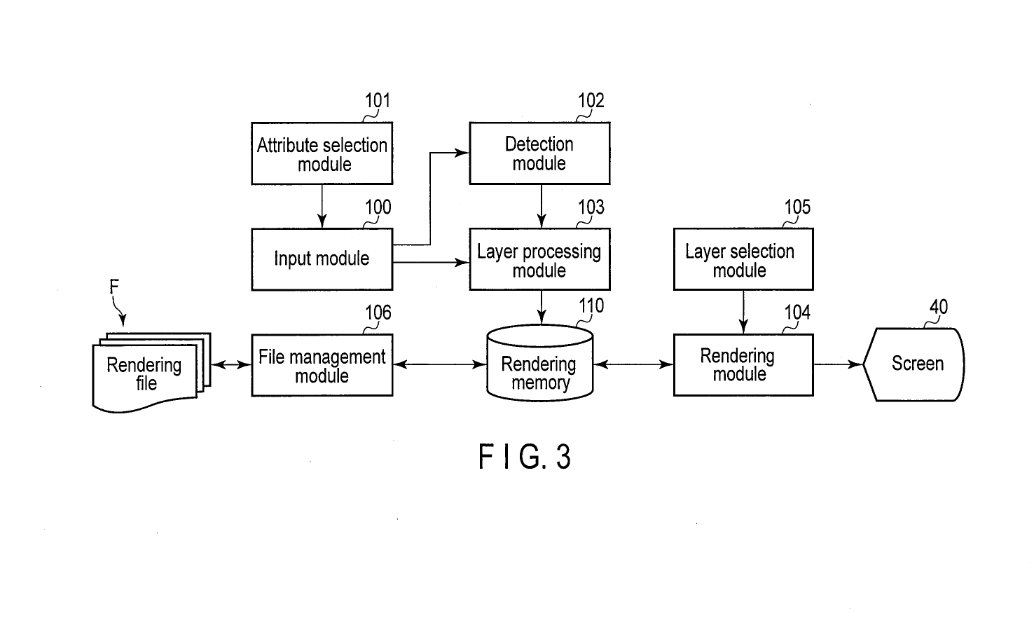

Now, main functions which the tablet computer 1 of the present embodiment has will be explained below with using the block diagram of FIG. 3. In the following description, attention will be given to the characteristic features of the tablet computer 1 of the present embodiment alone, and thus the explanation of the widely known functions will be omitted.

The tablet computer 1 has an input module 100, an attribute selection module 101 (an attribute selector), a detection module 102 (a detector), a layer processing module 103 (a layer controller), a rendering module 104 (a rendering controller), a layer selection module 105 (a layer selector), and a file management module 106 (a file manager).

Each of the modules 100-106 will be actualized by the CPU 10 executing a corresponding one of the respective computer programs, for instance. Each of the computer programs is a set of instructions that are concerned with rendering tools and are provided by the OS 20 or the application program 21, for instance.

The input module 100 inputs objects for providing an image on the screen 40. In the present embodiment, an “object” includes a stroke represented by a trail including positions successively specified at the detection surface, a character typewritten with a predetermined font, and a figure with a predetermined shape.

The “stroke” is a line segment obtained by joining the coordinates which the sensor board 33 and the digitizer controller 16 detect in time series from a moment that the indicator 50 touches the detection surface 30 till a moment that the indicator 50 leaves the detection surface 30, for instance. As explained above, the comparison between the brushstroke strength value and the threshold value makes it possible to determine whether or not the indicator 50 touches the detection surface 30. It is also possible that the stroke is a line segment obtained by joining the coordinates which the sensor board 33 and the digitizer controller 16 detect in time series when the user slides his or her finger on the detection surface 30, for instance.

The “character” is a character in a predetermined font such as Century, Arial, or Courier, for instance. Any character may be inputted by using a keyboard connected with the tablet computer 1 or a software keyboard displayed on the screen 40. Furthermore, the user can specify the input position of a character, a font type, a character size, etc., by performing manipulations on the detection surface 30 with his or her finger or with using the indicator 50.

The “figure” is a shape such as a straight line, a curved line, a circle, an ellipse, a polygon, a star, an arrow, etc. It is also possible that the “figure” is a photograph or an image that has a predetermined shape and is stored beforehand in the nonvolatile memory 13 or the like in a desired data format such as a bitmap format or a JPEG format, for instance. The user can specify the input position of a figure, a figure type, a figure size, etc., by performing manipulations on the detection surface 30 with his or her finger or with using the indicator 50.

When inputting a stroke, the input module 100 inputs a set of coordinates representing the stroke into the detection module 102 and the layer processing module 103 via the touch panel controller 15 and the digitizer controller 16. When inputting a character, the input module 100 inputs the character connected with the pressed key, a character display position of the screen 40, a font type, and a character size into the detection module 102 and the layer processing module 103. When inputting a figure, the input module 100 inputs a figure display position of the screen 40, a figure type, and a figure size into the detection module 102 and the layer processing module 103.

The attribute selection module 101 allows making a selection for each of the attributes of an object, which the user intends to input using the input module 100, in accordance with manipulations which the user performs on the detection surface 30, for instance. The “attributes” of an object are pieces of information on the characteristic features of the object. When the object is a stroke, for instance, the color of the stroke, the thickness of the stroke, the transparency of the stroke, and the texture of the stroke may be included in its attributes. In contrast, when the object is a character, the color of the character, the thickness of the character, the transparency of the character, the texture of the character, the font type of the character, and the size of the character may be included in its attributes. Furthermore, when the object is a figure, the color of the figure, the thickness of the frame line of the figure, the transparency of the figure, and the texture of the figure may be included in its attributes. The texture includes a wood grain pattern, a paper pattern, a stone pattern, a mesh pattern, etc. It should be noted that the elements enumerated above are merely some examples, and that it is possible to include other various elements into the attributes.

The detection module 102 detects one of the attributes of the object having been inputted by the input module 100. The detection module 102 notifies the layer processing module 103 of the detected attribute.

The layer processing module 103 assigns the object having been inputted by the input module 100 to a layer which is connected with the attribute having been detected by the detection module 102.

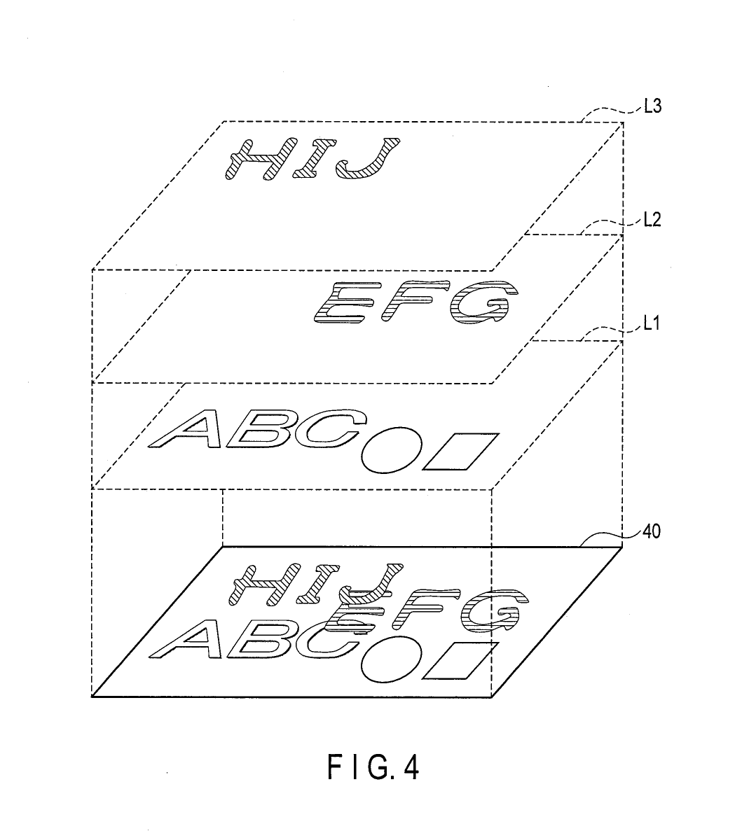

Now, how layers work will be explained with reference to FIG. 4. The screen 40 includes layers, which may be placed one upon another or hierarchically arranged. Any object having been inputted by the input module 100 will be assigned to one of the layers.

FIG. 4 indicates three layers L1, L2, and L3. The layer L1 is a lowermost layer. The layer L3 is an uppermost layer. The layer L2 is an intermediate layer that is between the layer L1 and the layer L3. The layer L1 is assigned characters “ABC” and two figures, a circle and a square. The layer L2 is assigned characters “EFG.” The layer L3 is assigned characters “HIJ.”

The characters “ABC” are individually typewritten using, for instance, the aforementioned software keyboard, etc. The attributes of each of the characters “ABC” include, for instance, a first color, a first font, and a first size. The circle and the square individually have attributes of their own, including a first color, a first thickness, and a first transparency, for instance. The characters “EFG” and “HIJ” are individually a set of strokes having been inputted by sliding the indicator 50 on the detection surface 30. The attributes of each of the characters “EFG” include, for instance, a second color, a second thickness, and a second transparency. The attributes of each of the characters “HIJ” include, for instance, a third color, a third thickness, and a third transparency.

Let us suppose that the present embodiment uses the color of an object as a decisive attribute, or a criterion, for determining a layer to which the layer processing module 103 assigns the object. In FIG. 4, for instance, the layer L1 is connected with the first color, the layer L2 the second color, the layer L3 the third color. Therefore, the characters “ABC” and the two figures, the circle and the square, each having the first color as one of their individual attributes, are assigned to the layer L1. Similarly, the characters “EFG”, each having the second color as one of their individual attributes, are assigned to the layer L2, and the “HIJ”, each having the third color as one of their individual attributes, are assigned to the layer L3.

The layer processing module 103 saves any object, which the input module 100 has inputted, in a rendering memory 110 along with the attributes of the object with keeping a condition that allows specifying the layer to which the object should be assigned. The rendering memory 110 may be a working memory area generated in the main memory 12, for instance. When the object is a stroke, for example, the layer processing module 103 saves in the rendering memory 110 object data including a set of coordinates representing the stroke, the attributes of the stroke, and the identifier of the layer to which the stroke should be assigned. In contrast, when the object is a character, the layer processing module 103 saves in the rendering memory 110 object data including the type of the character, the coordinates for delineating the character (for instance, the coordinates of the base point), the attributes of the character, and the identifier of the layer to which the character should be assigned. Furthermore, when the object is a figure, the layer processing module 103 saves in the rendering memory 110 object data including the type of the figure, the coordinates for delineating the figure (for instance, the coordinates of the base point), the attributes of the figure, and the identifier of the layer to which the figure should be assigned.

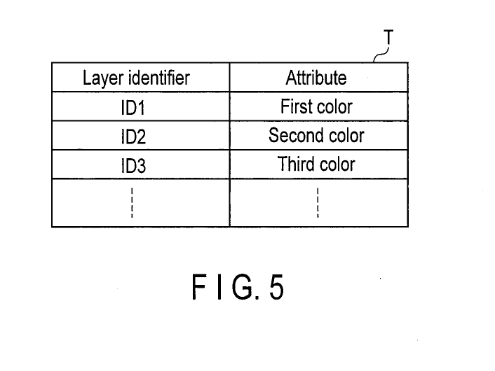

The relation between a layer and an attribute is managed by a management table T, which may be used for the management of data structures, as indicated in FIG. 5, for instance. The management table T is included in the rendering memory 110, for instance. The management table T includes at least one record for every layer. Each record includes an identifier assigned to a layer and an attribute assigned to the layer. FIG. 5 illustrates a management table T that includes records for the layers L1-L3 of FIG. 4. The first record includes ID1, which is an identifier assigned to the layer L1, and a first color, which is an attribute assigned to the layer L1. The second record includes ID2, which is an identifier assigned to the layer L2, and a second color, which is an attribute assigned to the layer L2. The third record includes ID3, which is an identifier assigned to the layer L3, and a third color, which is an attribute assigned to the layer L3. The records of the management table T illustrated in FIG. 5 are arranged in layer hierarchical order.

The rendering module 104 renders on the screen 40 the objects having been assigned to one or more layers. For instance, when the rendering module 104 renders all the objects, each having been assigned to any one of the layers L1-L3 of FIG. 4, it provides such an image that the three layers L1-L3, each carrying their respective groups of assigned objects, are placed one upon another as delineated in the screen 40 presented at the bottom of FIG. 4. Namely, upon rendering any two objects which are placed one upon another, the rendering module 104 places one of the objects having been assigned to an upper layer on the other of the objects having been assigned to a lower layer, as apparent from the relation among “C” of the layer L1, “E” of the layer L2, and “J” of the layer L3. It should be noted that the replacement of layer hierarchical order is possible.

The layer selection module 105 selects at least one layer, which is to be rendered, from the layers in accordance with the instruction of the user, for instance. The rendering module 104 renders on the screen 40 the objects assigned to the at least one layer having been selected by the layer selection module 105.

The file management module 106 generates a rendering file F, which includes the management table T and the object data, both having been obtained from the rendering memory 110. The file management module 106 then saves the rendering file F in a memory such as the nonvolatile memory 13. The file management module 106 gets access to the memory such as the nonvolatile memory 13, and loads into the rendering memory 110 the management table T and the object data included in the rendering file F.

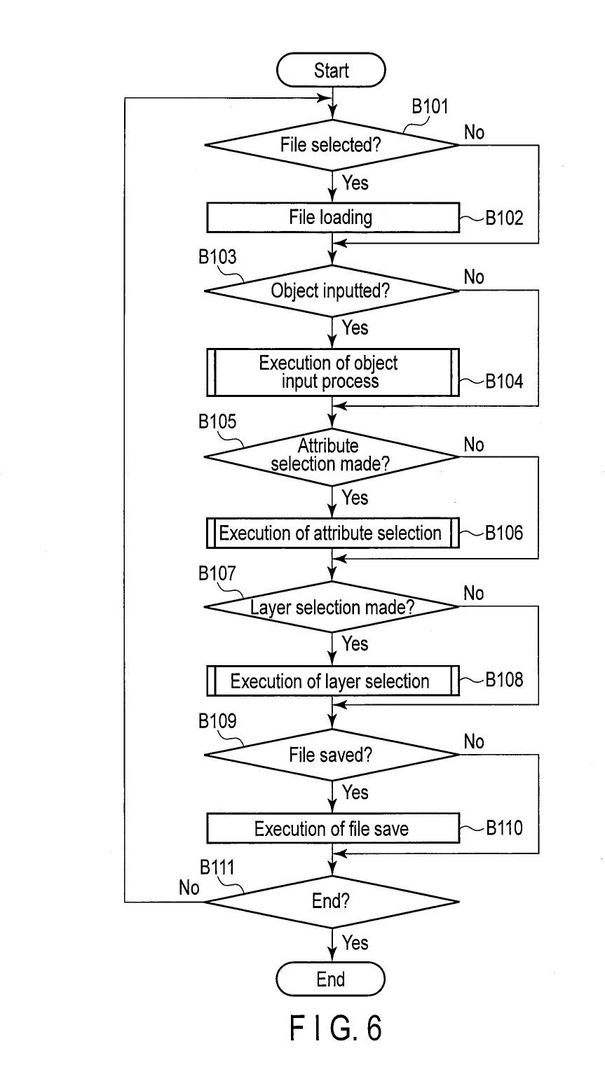

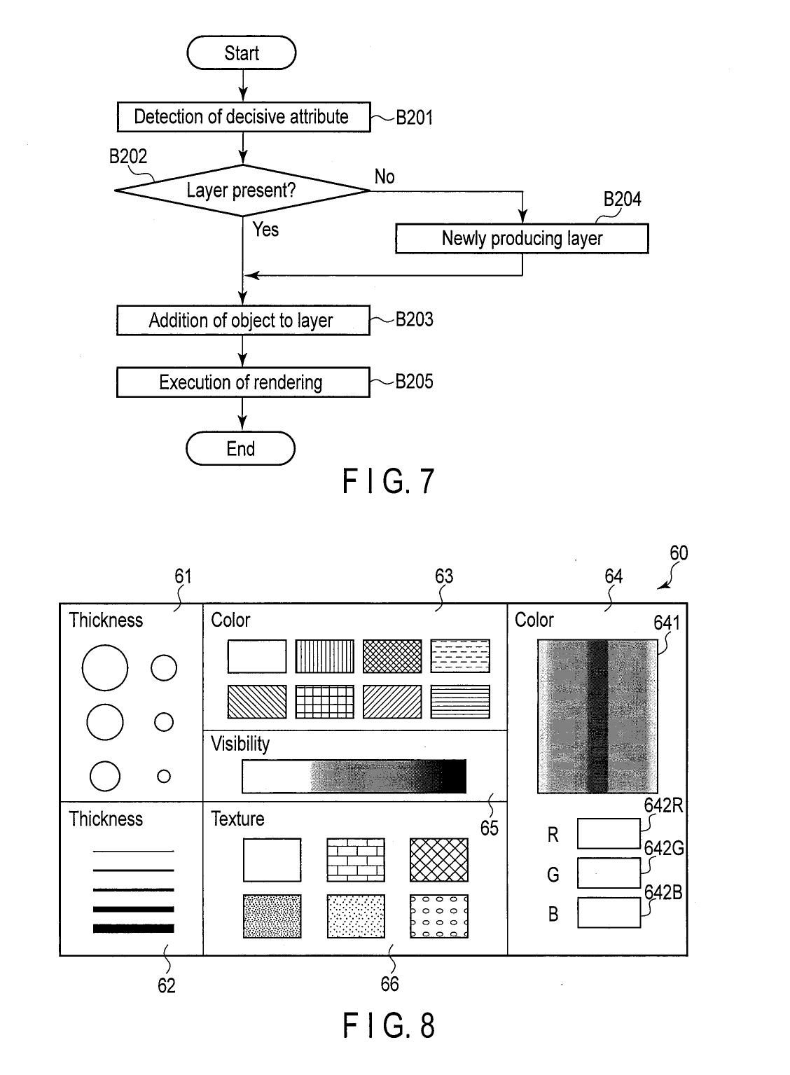

Now, the operation of the tablet computer 1 or a series of acts performed by the modules 100-106 will be explained below with reference to FIGS. 6 and 7.

A series of acts as indicated in the flow chart of FIG. 6 will be performed upon activation of the rendering tools provided by the OS 20 or the application program 21. In addition, the rendering memory 110 may be generated in the nonvolatile memory 13. At first, the rendering memory 110 does not include any object data, and the management table T does not include any record.

In the flow chart, the file management module 106 determines whether or not the rendering file F is selected as an object which the rendering tools process (Block B101). When the rendering file F is selected by the user's operation (“Yes” in Block B101), the file management module 106 loads into the rendering memory 110 the management table T and the object data, both included in the selected rendering file F. When the rendering file F is not selected (“No” in Block B101), the process indicated by the block B102 will be skipped.

While the rendering tools are active, the input module 100 accepts object input (Block B103). The input module 100 allows the user to input any object, which consists of at least one stroke, at least one character, or at least one figure, or any combination thereof, by performing manipulations on the detection surface 30 with his or her finger or with using the indicator 50. When any object has been inputted (“Yes” in Block B103), what has been inputted will be processed (Block B104).

FIG. 7 is a flow chart of an object input process. In the flow chart, the detection module 102 detects a decisive attribute for every inputted object (Block B201). As described above, the present embodiment uses color, which any object has as one of its attributes, as a decisive attribute, or a criterion, for determining a layer. Therefore, the detection module 102 detects color for every object as a decisive attribute of any object that has been inputted.

The layer processing module 103 determines whether a layer which is connected with the attribute having been detected at the block B201 is present or not (Block B202). For example, when a record keeping as an attribute a color that is the same as the color having been detected at the block B201 is found in the management table T of the rendering memory 110, the layer processing module 103 determines that a layer which is connected with the attribute having been detected at the block B201 is already present (“Yes” in Block B202). Then, the layer processing module 103 saves object data, which includes the identifier of the layer, in the rendering memory 110 (Block B203). Thus, it will be possible to assign any one of the inputted objects to some one of the (already-existing) layers that has the same attribute as the inputted object in question has.

In contrast, when a record keeping as an attribute a color that is the same as the color having been detected at the block B201 is not found in the management table T of the rendering memory 110, the layer processing module 103 determines that a layer which is connected with the attribute having been detected at the block B201 is not yet present (“No” in Block B202). Then, the layer processing module 103 newly produces a layer which is connected with the attribute having been detected at the block B201 (Block B204). Specifically, the layer processing module 103 adds to the management table T a new record keeping an identifier that does not overlap with any of the identifiers of the existing records, and enters in the newly added record the attribute having been detected at the block B201. After the block B204, the layer processing module 103 saves in the rendering memory 110 object data which includes the same identifier as what is entered in the new record (Block B203). Thus, it will be possible to assign the inputted object to the (newly produced) layer that has the same attribute as the inputted object has.

After the block B203, the rendering module 104 renders the objects on the screen 40 based on the object data having been saved in the rendering memory 110 at the block B203. The object input process will thus terminate.

Now, let us return to the explanation of the flow chart indicated in FIG. 6. While the rendering tools are active, the attribute selection module 101 allows making attribute selection (Block B105). The attribute selection module 101 allows the user to instruct the tablet computer 1 to execute the attribute selection by performing manipulations on the detection surface 30 with his or her finger or with using the indicator 50. When the execution of the attribute selection has been instructed (“Yes” in Block B105), the attribute selection module 101 will allow an execution of the attribute selection (Block B106).

In the attribute selection process, the attribute selection module 101 causes the screen 40 to display an attribute selection box 60 such as that indicated in FIG. 8, for instance. The attribute selection box 60 in this example includes a first box 61, a second box 62, a third box 63, a fourth box 64, a fifth box 65, and a sixth box 66.

The first box 61 is a box for selecting a thickness for a stroke, and a plurality of patterns (circular patterns in FIG. 8) representing difference in thickness are arranged in the box. The first box 61 allows the user to select a pattern representing a desired thickness by performing manipulations on the detection surface 30 with his or her finger or with using the indicator 50.

The second box 62 is a box for selecting a thickness for a frame line of a figure, and a plurality of lines representing difference in thickness are arranged in the box. The second box 62 allows the user to select a line representing a desired thickness by performing manipulations on the detection surface 30 with his or her finger or with using the indicator 50.

The third box 63 is a box for selecting a color for an object from a plurality of colors prepared in advance, and a plurality of areas representing different colors are arranged in the box. The third box 63 allows the user to select an area representing a desired color by performing manipulations on the detection surface 30 with his or her finger or with using the indicator 50.

The fourth box 64 is a box allowing the user to create any color in his or her discretion as a color for an object. The fourth box 64 includes a spectrum area 641 representing any color which can be made by changing the brightness of each of three colors, Read (R), Green (G), and Blue (B), an area 642R for specifying the brightness of Red, an area 642G for specifying the brightness of Green, and an area 642B for specifying the brightness of Blue. The fourth box 64 allows the user to specify a point in the spectrum area 641 that the user wants to set as the color for the object by performing manipulations on the detection surface 30 with his or her finger or with using the indicator 50. The fourth box 64 also allows the user to input any specified brightness into each of the areas 642R, 642G and 642B in his or her discretion by performing manipulations on the detection surface 30 with his or her finger or with using the indicator 50. A mixed color obtained by mixing the red, blue and green, each having its own brightness specified by the input to the corresponding one of the areas 642R, 642G and 642B, will be the color of the object. For instance, when red, green and blue are individually represented by 8 bits, brightness levels which can be inputted into each of the areas 642R, 642G and 642 B will be 0-255. It is possible to use some other color space, such as an HSV (Hue, Saturation, Value) color space, instead of an RGB color space.

The fifth box 65 is a box for selecting a level of visibility for an object, and the gradations of visibility are provided in the box. The fifth box 65 allows the user to select a desired level of visibility by performing manipulations on the detection surface 30 with his or her finger or with using the indicator 50.

The sixth box 66 is a box for selecting a texture for an object, and has inside of it a plurality of divided areas for exhibiting texture samples. The sixth box 66 allows the user to select any one of the divided areas that represents a desired texture by performing manipulations on the detection surface 30 with his or her finger or with using the indicator 50.

The attribute selection module 101 allows the user to select a thickness, a color, a level of visibility, and a texture by using the aforementioned respective boxes 61-66 and to set the selections as the attributes of an object, which the user is about to input.

It is possible to display the attribute selection box 60 on the screen 40 from the outset of starting the rendering tools. It is also possible that the attribute selection box 60 includes further boxes for allowing the user to select a font or a size for a character or to make selection for some other attributes. Furthermore, the method of selecting a thickness, a color, a level of visibility, and a texture for an object is not limited to what has been explained above, or the method which uses the boxes 61-66.

While the rendering tools are active, the layer selection module 105 allows making layer selection (Block B107). Specifically, the layer selection module 105 allows the user to instruct the tablet computer 1 to execute the layer selection by performing manipulations on the detection surface 30 with his or her finger or with using the indicator 50. When the execution of the layer selection has been instructed (“Yes” in Block B107), the layer selection module 105 will execute the layer selection (Block B108).

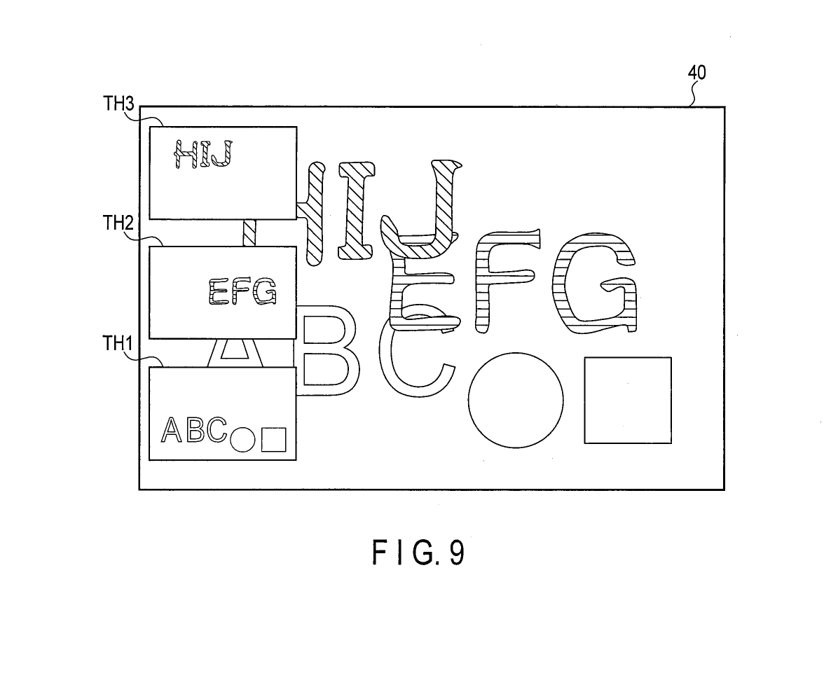

In the layer selection process, the layer selection module 105 causes the screen 40 to display a thumbnail for every layer that is connected with any one of the records in the management table T. FIG. 9 indicates one example of the screen 40 where some thumbnails are displayed. The example of the screen 40 illustrated in FIG. 9 corresponds to the aforementioned exemplified screen 40, which is illustrated in FIG. 4 and includes layers L1-L3. In this example however, three thumbnails TH1, TH2 and TH3 are additionally displayed on the screen. The thumbnail TH1 is connected with the layer L1, and thus it includes what are assigned to the layer L1, namely, the characters “ABC” and two figures, the circle and the square. The thumbnail TH2 is connected with the layer L2, and thus it includes the characters “EFG” (each being a set of strokes), which are assigned to the layer L2. The thumbnail TH3 is connected with the layer L3, and thus it includes the characters “HIJ” (each being a set of strokes), which are assigned to the layer L3. The layer selection module 105 allows the user to select at least one layer, which the user want to display on the screen 40, by performing manipulations of the thumbnails TH1, TH2 and TH3 with his or her finger or with using the indicator 50. In the example of FIG. 9, the thumbnails are arranged on the screen in such a manner that the hierarchical relation among the layers L1-L3 will be clarified, namely, the thumbnail TH3 connected with the uppermost layer L3 is displayed at the top left-hand corner, the thumbnail TH2 connected with the intermediate layer L2 occupies an intermediate left-hand side, and the thumbnail TH1 connected with the lowermost layer L1 is displayed at the bottom left-hand corner.

When a layer is selected as explained above, the layer selection module 105 notifies the rendering module 104 of the identifier of the selected layer. The rendering module 104 renders on the screen 40 only such an object that corresponds to an object data piece being included in the object data, which is saved in the rendering memory 110, and having the same identifier as what is notified by the layer selection module 105.

While the rendering tools are active, the file management module 106 accepts instructions for saving a file (Block B109). The file management module 106 allows the user to instruct the tablet computer 1 to save any file by performing manipulations on the detection surface 30 with his or her finger or with using the indicator 50. When saving a file is instructed (“Yes” in Block B109), the file management module 106 generates a rendering file F, which includes the management table T and the object data, both having been obtained from the rendering memory 110. The file management module 106 then saves the rendering file F in a memory such as the nonvolatile memory 13 (Block B110).

The steps form the block B101 to the block B110 will be repeated until the rendering tools are terminated. The user can instruct the tablet computer 1 to terminate the rendering tools by performing manipulations on the detection surface 30 with his or her finger or with using the indicator 50. When the termination of the rendering tools is instructed (“Yes” in Block B111), the whole process indicated in the flow chart of FIG. 6 will be terminated.

As explained above, the tablet computer 1 in the present embodiment assigns an object having been inputted with the use of the screen 40 to the layer that has the same attribute as the inputted object has. When there exists no layer that has the same attribute as the inputted object has, the tablet computer 1 newly produces a layer having the same attribute as the inputted object has, and assigns the inputted object to the newly produced layer. There is no need for the user to make any specific operation in order to assign an inputted object to a layer or in order to produce a layer. Therefore, the object management will be extremely easy.

In the attribute selection process of the block B106, the user can select an attribute for an object, which allows the user to change one layer for another to which an inputted object will be assigned.

In the layer selection process of the block B108, the user can select a layer, which the user wants to be rendered on the screen. This means that the user can render on the screen 40 only those objects that have a specific attribute in common among the objects having been previously inputted.

One exemplary application of the tablet computer 1 in the above embodiment will be explained below. In this exemplary application, it is assumed that a student writes his or her own answers to a test on his or her tablet computer 1, and a teacher marks the answers to the test using his or her tablet computer 1. It is not necessary that the tablet computer 1, which the student uses, and the tablet computer 1, which the teacher uses, should be the same.

A rendering file F, which includes a first layer to which articles each asking a question and including characters of a first color are assigned, is saved in the student's tablet computer 1. The student manages his or her own tablet computer 1 to load the rendering file F, and inputs handwritten answers by using the indicator 50. The strokes produced by inputting the handwritten answers have a second color in common. The strokes produced by inputting the handwritten answers are assigned to a second layer which is connected with the second color. When time is up, the student saves his or her rendering file F, which includes the layer 1 and the layer 2.

When giving marks, the teacher instructs his or her tablet computer 1 to load the rendering files F, which the student saved. The teacher gives marks through handwritten input using the indicator 50 to the test answers. The strokes, which the teacher produces by the handwritten input, have a third color in common. The strokes, which the teacher inputs, are assigned to a third layer, which is connected with the third color. Whenever giving marks to each of the test answers is completed, the teacher saves his or her rendering file F, which includes the first layer through the third layer.

Upon confirmation of test results, the student instructs his or her tablet computer 1 to load the rendering file F which includes marks given by the teacher. The screen 40 then displays all the objects assigned to the first layer through the third layer, and thus the articles each asking a question, the answers which he or she inputted, and pieces of writing which the teacher inputted when the teacher gave marks are displayed on the screen 40.

At this moment, it may occur that the characters in the different layers overlap one another, and thus some of a first combination of characters expressing a question, some of a second combination of characters written by the student as an answer to the question, and some of a third combination of characters written by the teacher as a review of the answer may be indistinguishable from one another. Even so, it is possible for the student to make the screen 40 display only those contents that he or she wishes to be displayed among the articles each asking a question, the answers which he or she inputted, and the reviews which the teacher inputted.

What has been explained above is not the only application, but the tablet computer 1 in the present embodiment may be used in a variety of occasions.

### Modified Embodiment

Some modifications of the above-mentioned embodiment will be explained below.

In the above embodiment, a tablet computer was disclosed as one example of an electronic device. However, the structure, which is the same as that of the tablet computer in the above embodiment, may be applicable to various electronic devices, such as a notebook-sized personal computer, a smart phone, a portable game machine, a PDA, a digital camera, etc.

In the above embodiment, the layer processing module 103 uses color of an object as a decisive attribute, or a criterion, for determining a layer to which the object is assigned. However, color is not the only attribute that can be used as a criterion.

For instance, the thickness of an object may be employed as an attribute that can be used as a criterion. In such a case, the detection module 102 detects as a decisive attribute a thickness for every object that has been inputted. The thickness here is what is selected using the first box 61 illustrated in FIG. 8 in the case that the object in question is a stroke. Whereas, in the case that the object in question is a figure, the thickness is what is selected using the second box 62 illustrated in FIG. 8. It is possible to employ any other method to select a thickness for an object. The layer processing module 103 produces layers according to difference in thickness among the inputted objects, and assigns every object to some layer that is connected with the thickness which the detection module 102 has detected as a decisive attribute for every object.

Furthermore, the level of visibility of an object may be employed as a decisive attribute or a criterion. In such a case, the detection module 102 detects as a decisive attribute a level of visibility for every object that has been inputted. The level of visibility here is what is selected using the fifth box 65 illustrated in FIG. 8, for instance. It is possible to use any other method to select a level of visibility for an object. The layer processing module 103 produces layers according to difference in level of visibility among the inputted objects, and assigns every object to some layer that is connected with the level of visibility which the detection module 102 has detected as a decisive attribute for every object.

Furthermore, the texture of an object may be employed as a decisive attribute or a criterion. In such a case, the detection module 102 detects as a decisive attribute a texture for every object that has been inputted. The texture here is what is selected using the sixth box 66 illustrated in FIG. 8, for instance. It is possible to use any other method to select a texture for an object. The layer processing module 103 produces layers according to difference in texture among the inputted objects, and assigns every object to some layer that is connected with the texture which the detection module 102 has detected as a decisive attribute for every object.

Furthermore, the tip shape of an indicator (the thickness of the tip or the area of the detection surface where the tip contacts) may be used as a decisive attribute or a criterion. For instance, the use of a touch panel of a capacitance type and the indicator having a tip made of conductive material makes it possible to detect a group of coordinates that represents the shape of the tip of the indicator. In such a case, the detection module 102 detects as a decisive attribute of an object that has been inputted a tip shape of an indicator which is represented by the group of coordinates having been detected by the touch panel 32. The layer processing module 103 produces a layer for every tip shape of the indicator, and assigns every inputted object to some layer that is connected with the tip shape which the detection module 102 has detected as a decisive attribute for every object.

Furthermore, at least one of the date and time when an object is inputted may be used as a decisive attribute or a criterion. In such a case, the detection module 102 detects a date or a time from a timer which the tablet computer 1 has, for instance. When the date is used as a decisive attribute or a criterion, the layer processing module 103 produces a layer for every date, and assigns every inputted object to some layer that is connected with the date which the detection module 102 has detected as a decisive attribute for every object. When the time is used as a decisive attribute or a criterion, the layer processing module 103 produces a layer for every time period such as 12:00-13:00, for instance, and assigns every inputted object to some layer that is connected with the time period which the detection module 102 has detected as a decisive attribute for every object.

Furthermore, a user (or an individual) who has inputted an object may be a decisive attribute or a criterion. When an object includes strokes, for instance, the detection module 102 detects an individual who has inputted the strokes based on the handwriting represented by the strokes. Various handwriting-recognition techniques may be used to recognize the handwriting from the strokes. For instance, the detection module 102 identifies an individual by analyzing the characters and figures, both of which are composed of strokes, extracting characteristic features from the analyzed characters and figures, and collating the extracted characteristic features with the database, with which characteristic features of individual handwriting, which a plurality of persons individually made by hand, are registered.

Furthermore, it is also possible that the detection module 102 identifies an individual based on the ID of a user who has already logged in the OS 20 or the application program 21 when an object is inputted.

Furthermore, it is also possible that the detection module 102 identifies an individual based on an input speed of an object. When strokes are inputted as an object, for instance, the input speed will be a writing speed, whereas when typewritten characters are inputted as an object, the input speed will be a typewriting speed.

Furthermore, it is also possible that the detection module 102 identifies an individual based on an input error frequency when an object includes typewritten characters. The input error frequency may be the frequency of erasure of any characters that have been once inputted, for instance.

When it is determined that each individual should be a decisive attribute or a criterion, the layer processing module 103 produces a layer for every individual, and assigns every inputted object to some layer that is connected with each individual who has been identified by the detection module 102 for every object.

It may be possible to assign to the same layer the objects that are similar in decisive attribute or criterion. For instance, when color is used as a decisive attribute or criterion as the aforementioned embodiment, it may be possible that the objects that are similar in color should be regarded as having an identical attribute and be assigned to a single layer. A specific example will be given below.

Let us suppose that R1, G1 and B1 respectively denote the brightness of red, the brightness of green, and the brightness of blue for a first color, that R2, G2 and B2 respectively denote the brightness of red, the brightness of green, and the brightness of blue for a second color, and that there is already produced a layer that is connected with the first color. When an object having the second color is inputted under such a circumstance, and when the conditions that R1−E≦R2≦R1+E and G1−E≦G2≦G1+E and B1−E≦B2≦B1+E are satisfied, then the layer processing module 103 assigns the object having the second color to the layer that is connected with the first color. When the above conditions are not satisfied, then the layer processing module 103 newly produces a layer that is connected with the second color, and assigns the object having the second color to the newly produced layer. The character “E” denotes a constant determining a range in which any brightness may be regarded as similar. The above-mentioned layer management makes it possible to prevent a situation in which a lot of layers are unnecessarily produced in accordance with strictly classified attributes.

In the above example, every time an object is inputted, the object is assigned to any one of the layers. However, it is possible to collectively execute at a specific moment both the assignment of objects to layers and the creation of layers. The time when a rendering file F is saved may be cited as one example of such a specific moment, for instance.

It is possible to suitably change the order of executing the blocks illustrated in the flow chart of FIG. 6 or FIG. 7.

The computer programs for implementing an input module 100, an attribute selection module 101, a detection module 102, a layer processing module 103, a rendering module 104, a layer selection module 105, and a file management module 106 may be stored in a non-transitory computer readable storage medium, such as a portable flash memory or a CD-ROM, and may be transferred as such a tangible commodity. It is also possible that the computer programs are downloaded into an electronic device through a network.

Furthermore, when an electronic device is capable of communicating with a cloud system, it is possible that at least a portion of the modules 100-106 is implemented by a server included in the cloud system. In such a case, a so-called Software as a Service (SaaS) type cloud system may be used.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an input controller configured to receive data indicative of an object to be rendered on a screen comprising layers;
a detector configured to detect an attribute of the object received by the input controller;
a layer controller configured to assign the object to either an existent layer or a new layer belonging to the layers of the screen, the layers connected with attributes; and
a rendering controller configured to render on the screen, objects assigned to the layers.

2. The electronic device of claim 1, wherein, in a case where there already exists the existent layer connected with the attribute of the object, the layer controller assigns the object to the existent layer, whereas, in a case where there exists no layer connected with the attribute of the object, the layer controller newly produces the new layer connected with the attribute, and assigns the object to the new layer.

3. The electronic device of claim 1, wherein the input controller is configured to receive as the data indicative of the object a stroke represented by a trail comprising positions successively specified at a detection surface.

4. The electronic device of claim 1, wherein the input controller is configured to receive as the data indicative of the object a character having a first font at a specified position of the screen.

5. The electronic device of claim 1, wherein the input controller is configured to receive as the data indicative of the object a figure having a first shape at a specified position of the screen.

6. The electronic device of claim 1, wherein
the detector is configured to detect as the attribute a color used for rendering on the screen the object; and
the layer controller is configured to assign the object to a layer connected with the color detected by the detector.

7. The electronic device of claim 1, wherein
the detector is configured to detect as the attribute a thickness used for rendering the object on the screen; and
the layer controller is configured to assign the object a layer connected with the thickness detected by the detector.

8. The electronic device of claim 1, wherein
the detector is configured to detect as the attribute a level of visibility used for rendering the object on the screen; and
the layer controller is configured to assign the object to a layer connected with the level of visibility detected by the detector.

9. The electronic device of claim 1, wherein
the detector is configured to detect as the attribute a texture used for rendering the object on the screen; and
the layer controller is configured to assign the object to a layer connected with the texture detected by the detector.

10. The electronic device of claim 1, wherein
the detector is configured to detect as the attribute at least one of a date and a time of receiving the data indicative of the object by the input controller; and
the layer controller is configured to assign the object to a layer connected with the at least one of the date and the time detected by the detector.

11. The electronic device of claim 1, wherein
the detector is configured to detect as the attribute an individual having inputted the object using the input controller; and
the layer controller is configured to assign the object to a layer connected with the individual detected by the detector.

12. The electronic device of claim 1, further comprising an attribute selector configured to select the attribute for the object to be inputted,
wherein the input controller is configured to receive the data indicative of the object having the attribute selected by the attribute selector.

13. The electronic device of claim 1, further comprising a layer selector configured to select at least one layer from the layers,
wherein the rendering controller is configured to render on the screen the object assigned to the at least one layer selected by the layer selector.

14. The electronic device of claim 13, wherein the layer selector is configured to display thumbnails of the layers on the screen, and to select a layer connected with the thumbnail which is specified by a user.

15. A method of rendering an object by an electronic device comprising:
receiving data indicative of an object to be rendered on a screen comprising layers;
detecting an attribute of the object;
assigning the object to either an existent layer or a new layer of the layers of the screen, the layers connected with attributes; and
rendering on the screen, objects assigned to the layers.

16. A non-transitory, computer-readable storage medium having stored thereon a computer program which is executable by a computer, the computer program controls the computer to execute function of:
receiving data indicative of an object to be rendered on a screen comprising layers;
detecting an attribute of the object;
assigning the object to either an existent layer or a new layer of the layers of the screen, the existent layers connected with attributes; and
rendering on the screen, objects assigned to the layers.
